(19) United States
(12) Patent Application Publication
(10) Pub. No.: US 2024/0297446 A1
(43) Pub. Date: Sep. 5, 2024

(54) ELECTRICAL CONNECTION DEVICE

(71) Applicant: SCHALTBAU GMBH, München (DE)

(72) Inventors: Michael SCHAMBACH, Dortmund (DE); Sven Hartenbach, Muenchen (DE); Florian Hupfeld, Muenchen (DE)

(73) Assignee: SCHALTBAU GMBH, München (DE)

(21) Appl. No.: 18/278,491

(22) PCT Filed: Feb. 16, 2022
(86) PCT No.: PCT/EP2022/053766

§ 371 Date: Aug. 23, 2023

(30) Foreign Application Priority Data
Feb. 23, 2021 (DE) 10 2021 104 244.5

(51) Int. Cl. H01R 4/50

(52) U.S. Cl. CPC H01R 4/50

(57) ABSTRACT

Disclosed is a device where a male contact body can be inserted into the female contact body along an insertion direction and the male contact body has a cavity which reaches through the male contact body; and a spreading element, which is inserted into the cavity and which has cross-sections that taper along the longitudinal axis of the spreading element in the securing direction, wherein the spreading element can be converted from a released position into a tightened position along the securing direction such that the male contact body is spread apart, thus generating a contact pressure between the female contact and the male contact body. In the process, the cavity reaches through the entire male contact body and thus forms two openings on the male contact body. The inner face of the male contact body has a first latching element, and the outer face of the spreading element has a second latching element, the first latching element latching with the second latching element when the spreading element reaches the tightened position so that the spreading element is secured in the tightened position.

The present invention relates to an electrical connection device according to the preamble of independent claim 1. In particular, the electrical connection device is used to connect busbars to one another.

A generic electrical connection device comprises a female contact and a male contact body configured such that the male contact body is insertable into the female contact along an insertion direction and the male contact body has a cavity extending through the male contact body, the cavity being bounded by an inner surface of the male contact body, the device further comprising a spreader element inserted into the cavity, which has cross-sections tapering along its longitudinal axis in a locking direction, the spreader element being transferable along the locking direction from a released position to a tightened position in such a way that the male contact body is spread open and a contact pressure is thereby generated between the female contact and the male contact body. In this case, the cavity extends through the entire male contact body and thus forms two openings on the male contact body.

An electrical connection device according to the preamble of independent claim 1 is known from EP 2 141 719 A1. This electrical connection device is a disconnector which can be moved between two positions. The maintenance of the contact pressure between the male contact body and the female contact is effected here by a frictional connection between the male contact body, the female contact and the spreader element. The contact pressure and thus the contact is not ensured in such an arrangement under certain disturbing influences such as vibrations of the connecting device.

It is the object of the present invention to provide an improved electrical connection device of the generic type which better ensures contact pressure and thus contact.

The task is solved by the features of independent claim 1. Accordingly, in an electrical connection device according to the preamble of independent claim 1, there is a solution to the task according to the invention if the inner side of the male contact body has a first latching element and an outer side of the spreader element has a second latching element, the first latching element latching with the second latching element when the spreader element reaches the tightened position, so that a securing of the spreader element in the tightened position is produced.

The solution according to the invention offers the advantage that the fuse is simple and inexpensive to manufacture. Furthermore, the electrical connection device according to the invention allows the contact pressure generated to be fixed by design, since the tightened position of the spreader element and thus the contact pressure are predetermined by the latching of the first latching element and the second latching element. In addition, there is thus no risk that a user will not sufficiently spread the male contact body by moving the spreader element and thus the contact pressure is too small or that a user will move the spreader element too far into the male contact body and thus damage the male contact body and or the female contact.

Advantageous embodiments of the present invention are the subject of the subclaims.

In a preferred embodiment of the present invention, it is provided that the cavity tapers in the locking direction in such a way that the male contact body spreads out in such a way that a planar contact between the inner side of the male contact body and an outer surface of the spreader element is obtained when the spreader element is in the tightened position. The planar contact results in an improved frictional connection and the contact body is held in the tightened position by this frictional connection in addition to the latching of the first latching element and the second latching element.

In another preferred embodiment of the present invention, it is provided that the first latching element and/or the second latching element have a rounding so that non-destructive release of the latch between the first latching element and the second latching element is possible by applying force to the expanding element in the opposite direction to the locking direction. Thus, the connection can be reused and components attached to the respective side of the connection can be replaced.

Further preferably, the male contact body has slots at its axial end lying opposite to the locking direction, so that the male contact body can be spread open in this region under the action of less force by the spreader element. This reduces the force required to produce the required spreading of the male contact body in order to generate the desired contact pressure. In addition, this allows the deformation of the male contact body to be largely or completely within the elastic region, which increases reusability.

It is of particular advantage if the insertion direction and the locking direction are parallel and opposite. This enables a simple and compact design of the electrical connection device.

It is also of particular advantage if the female contact and the male contact body are formed in such a way that they are coaxially aligned with each other when the male contact body is inserted into the female contact. Preferably, the spreader element is also formed such that it is coaxially aligned with the male contact body. In this way, a simple structure and a uniform distribution of forces can be achieved.

According to another preferred embodiment of the present invention, a cross-sectional area of the cavity and a cross-sectional area of the spreader element each have a circular shape, preferably a circular area. This, on the one hand, simplifies the alignment of the spreader element with respect to the cavity and, on the other hand, results in a better distribution of the contact pressure between the female contact and the male contact body. In addition, the contact area between the spreader element and the inside of the male contact body, which causes the frictional connection between these elements, is maximized.

According to a further preferred embodiment, a contact surface on an outer side of the male contact body has contact-forming elevations. Preferably, the contact-forming elevations are formed as webs, which preferably extend in the locking direction along the outer side of the male contact body. The contact-forming elevations result in a plurality of contact points between the male contact body and the female contact. This lowers the contact resistance. In addition, the elevations increase the frictional resistance between the male contact body and the female contact.

In a further preferred embodiment of the present invention, it is provided that the spreader element has the second latching element as a circumferential projection on its outer side and the male contact body has the second latching element as a circumferential groove on its inner side, wherein the projection and the being formed in a form-fitting manner with respect to one another. This enables secure latching of the first latching element and the second latching element while at the same time providing a simple structure for the individual components. The circumferential latching also increases the security of the spreader element in the tightened position against vibrations or impacts from individual directions.

Advantageously, the circumferential projection and the circumferential groove are configured such that the spreader element is non-destructively movable into and out of the tightened position by sliding a surface of the projection off a surface of the groove, under the action of a force acting in or against the locking direction on the spreader element

In another preferred embodiment of the present invention, it is provided that the outer side of the male contact body comprises a third latching element and an inner side of the female contact comprises a fourth latching element, wherein the third latching element engages with the fourth latching element when the spreader element reaches the tightened position, so that a securing of the contact between male contact body and female contact is created. By this additional securing, the contact between male contact body and female contact is additionally secured against vibrations.

In a particularly preferred embodiment of the present invention, it is provided that the device comprises a movement mechanism which causes the movement of the spreader element, the movement mechanism being lockable when the spreader element is in the tightened position. This allows additional securing of the spreader element in the tightened position, thereby securing the contact pressure.

Advantageously, the movement mechanism comprises a lever which is rotatably mounted about a pivot axis relative to the male contact body, wherein a first leg of the lever attaches to a region of the spreader element which extends out of the cavity of the male contact body in the locking direction such that movement of the lever between an open position and a closed position causes movement of the spreader element between the released position and the tightened position. This embodiment of the movement mechanism is constructively inexpensive to implement.

Further preferably, a releasable securing of the lever locks the lever in the closed position as soon as the lever reaches the closed position. Such a releasable securing of the lever can be implemented constructively in various ways in a safe, cost-effective and simple manner.

Advantageously, the securing of the lever is designed as a snap element in the form of a hook, whereby the hook hooks onto a second leg of the lever, which is opposite the first leg of the lever with respect to the pivot axis, when the lever is transferred from the open position to the closed position. This ensures that the lever is secured in the closed position.

In a particularly preferred embodiment of the present invention, it is provided that the device comprises a housing. Advantageously, the housing surrounds the male contact body at least in regions. The housing can perform various advantageous tasks in this regard. For example, it can act as a protection against dirt which is to be kept away from the electrical connection. In addition, it can serve as a suspension for components of the connection device and assume an electrically insulating effect.

Advantageously, the housing forms an assembly with the male contact body. Thus, the housing can be pre-assembled with the male contact body.

According to a further preferred embodiment, the housing is configured such that the female contact is insertable between the male contact body and a housing part. Preferably, the housing part is designed as a sleeve and is further preferably aligned coaxially with the male contact body. Preferably, the outer side of the female contact contacts the inner side of the housing part when the male contact body is inserted into the female contact. This simplifies the alignment of the male contact body with the female contact, and the contact surface between the male contact body and the female contact is further protected from contamination. Preferably, the housing part is configured such that the housing part stabilizes the female contact during a spreading of the male contact body from the outside. This counteracts plastic deformation of the female contact, which among other things increases the reusability of this component, since the housing part supports the female contact.

In a preferred embodiment of the present invention, it is provided that the lever is mounted on the housing. This enables a compact design of the connecting device. Preferably, the snap element is formed as part of the housing. This enables an even more compact structure.

According to another preferred embodiment, an additional housing forms an assembly with the female contact and is configured such that the housing of the assembly with the male contact body is insertable between the additional housing and the female contact. Preferably, the additional housing is formed as a sleeve that is preferably coaxially aligned with the female contact. Preferably, the outside of the housing contacts the inside of the additional housing when the male contact body is inserted into the female contact. This further simplifies the alignment between the male contact body and the female contact, and provides effective insulation and very effective protection against contamination. In addition, this ensures that the contact surfaces of the male contact body and the female contact are largely protected from manual access, which increases safety when using the connection device.

According to another preferred embodiment, the female contact sits on a first surface of a connector member, wherein an axis of the female contact with the first surface includes an angle between 70° and 90°, and wherein the connector member includes a section disposed on the first surface, wherein an intersection angle between a normal vector of the section and a normal vector of the first surface is between 70° and 90°, wherein the section is surrounded with a layer of an insulating material. This enables a space-saving and safe construction of the connecting device. The section with the insulating layer thereby protects further components from any sparks that might occur during the connection between the male contact body and the female contact.

Advantageously, the additional housing is integrally formed of the same insulating material as the layer around the portion of the connecting member. Further preferably, the first surface of the connector is also surrounded by the insulating material and the additional housing is integrally formed with the insulating material around the first surface of the connector. Further preferably, the additional housing is integrally formed with the insulating material around the first surface and around the portion of the connecting member. This allows for a particularly simple production of the additional housing and reduces the number of necessary production steps.

An embodiment of the present invention is explained in more detail below with reference to drawings.

It show:

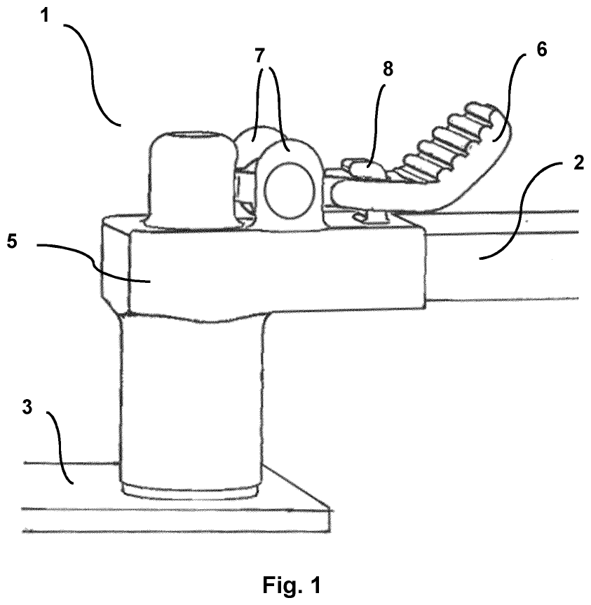

FIG. 1 an oblique view of an embodiment of the invention,

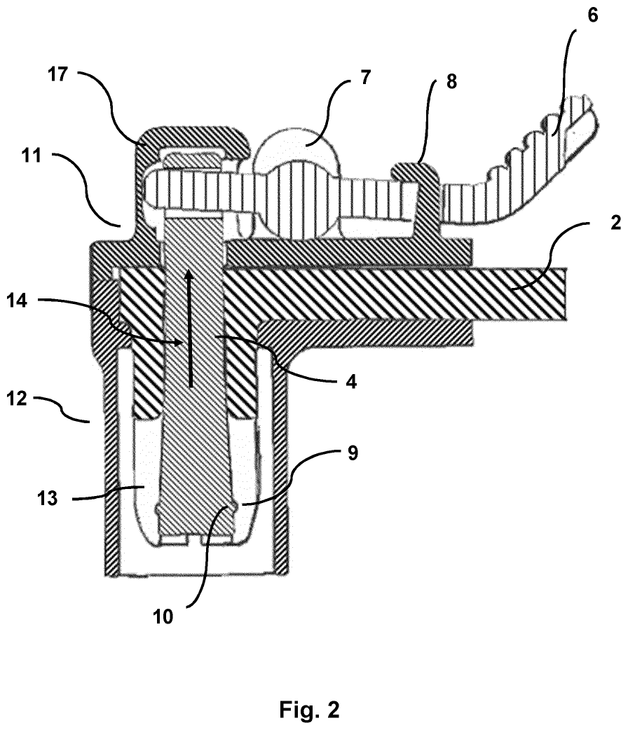

FIG. 2 a section through the embodiment example without the female contact,

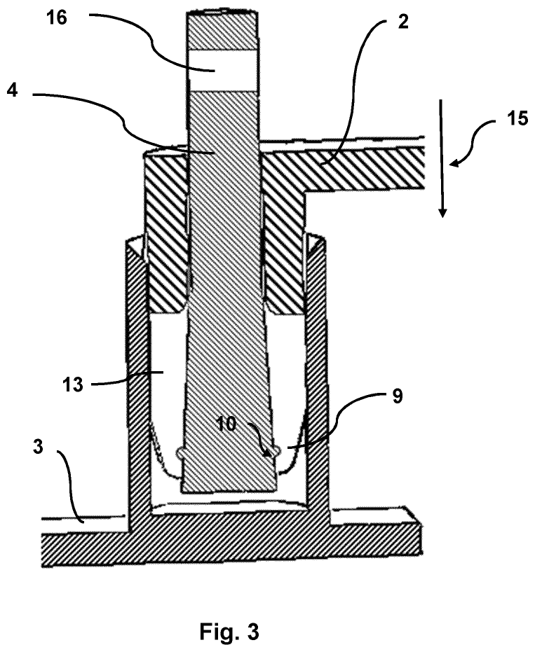

FIG. 3 a section through the embodiment without the housing,

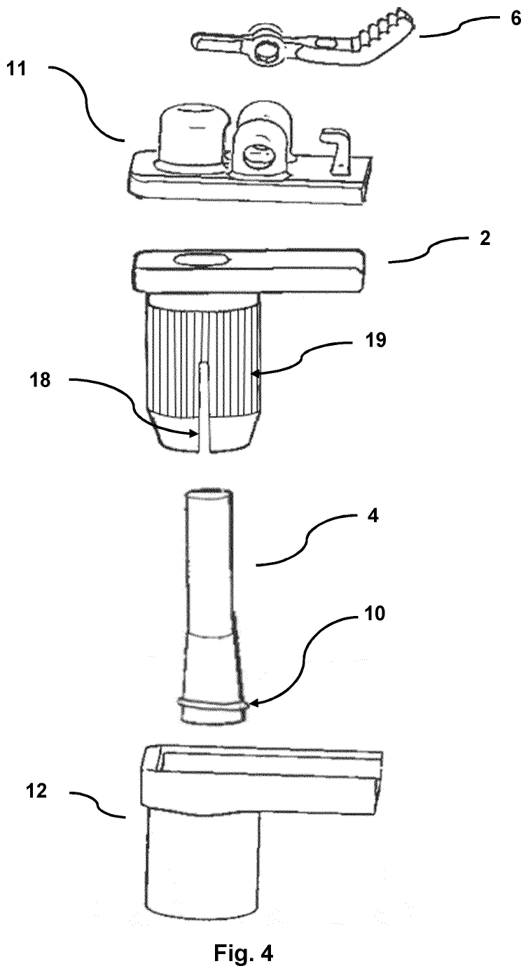

FIG. 4an exploded view of an assembly of the embodiment comprising a male contact body, a lever, an spreader element, and first and second housing parts,

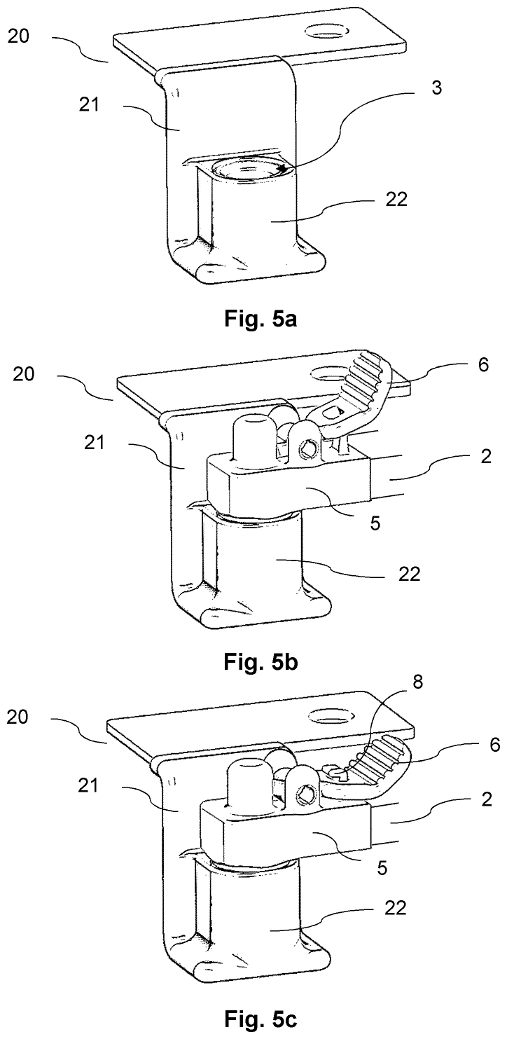

FIG. 5a, b, c An oblique views of the embodiment with additional housing around female contact during various process steps to close the connection between female contact and male contact body,

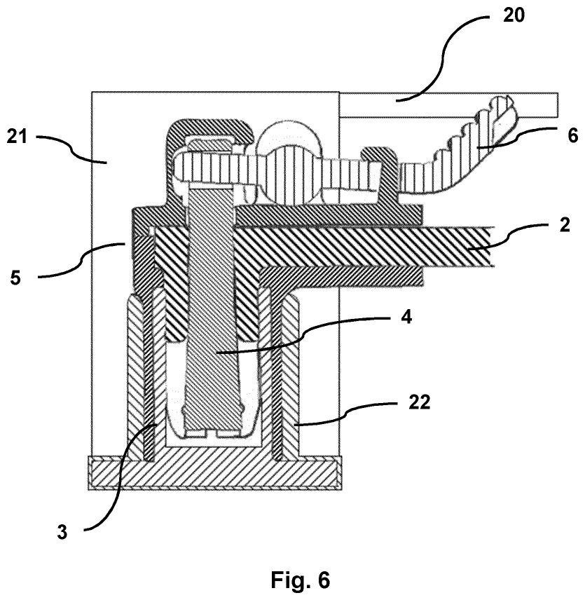

FIG. 6a section through the embodiment with additional housing.

In the following explanations, the same parts are designated by the same reference signs. If a figure contains reference signs which are not described in detail in the associated figure description, reference is made to the preceding or following figure descriptions.

FIGS. 1 to 4 show an embodiment example of the present invention. Here, FIG. 1 shows an oblique view of the embodiment example of the electrical connection device 1 from an oblique top view. FIG. 2 shows a sectional view of the electrical connection device 1 without the female contact 3. FIG. 3 also shows a sectional view of the electrical connection device 1, although the housing 5 and the lever 6 are not shown here. Lastly, FIG. 4 shows an exploded view of the assembly consisting of the male contact body 2, the lever 6, the spreader element 4 and the housing 5, which consists of a first housing part 11 and a second housing part 12.

The embodiment example of the electrical connection device 1 comprises a male contact body 2 and a female contact 3, between which an electrical contact with a specific contact pressure is to be generated by the electrical connection device. For this purpose, the male contact body 2 is guided into the female contact 3 in an insertion direction 15. The female contact 3 is thereby designed as a sleeve. A conical cavity extends through the male contact body 2, which completely penetrates the male contact body 2. In other embodiment examples, the cavity may also be cylindrical, cuboidal or pyramid-shaped, among others. Within this cavity is a likewise conical spreader element 4, which can be moved from a released position to a tightened position by a movement in a locking direction 14. The spreader element 4 may also deviate from the conical shape here in other embodiments. However, the spreader element 4 must have tapered cross-sections in the locking direction 14. The movement of the expanding element 4 in the locking direction 14 from a released position to a tightened position causes an area of the male contact body 2 to expand, so that a contact pressure is generated between the male contact body 2 and the female contact 3. In this case, the male contact body 2 has ridges 19 on its outer surface, which lower the contact resistance between the male contact body 2 and the female contact 3. It should be noted that in FIGS. 1 to 4, the spreader element 4 is shown in the tightened position and the male contact body 2 is shown inserted into the female contact 3, respectively. Thus, the arrows representing any directions of movement of various components represent only the general direction of such movement.

Thereby, in the area of the male contact body 2 that is spread open by the movement of the spreader element 4, the male contact body 2 is formed with slits 18 so that more flexible fingers 13 are formed and the spreading is an elastic deformation. In this area of the male contact body 2, there is also a first latching element 9 in the form of a circumferential groove 9 formed circumferentially in the inner side of the male contact body which surrounds the conical cavity. On the outside of the spreader element is a second latching element 10, which is formed as a projection in the form of a bead 10, the geometry of the bead 10 allowing a form fit with the circumferential groove 9. The first latching element 9 and the second latching element 10 result in a securing of the spreader element in the tightened position, since the bead 10 engages in the circumferential groove 9 as soon as the spreader element has been guided into the tightened position. This allows the tightened position of the spreader element 4 and thus the contact pressure between the male contact body 2 and the female contact 3 to be secured. Furthermore, this allows a design specification of the contact pressure, since the latching of the second latching element 10 with the first latching element 9 signals to the user that the desired final position of the spreader element 4 has been reached. On the one hand, the geometry of the bead 10 in combination with the geometry of the circumferential groove 9 enables a non-destructive latching of the second latching element 10 with the first latching element 9, since the two curves can slide into each other. In addition, non-destructive disengagement of the second latching element 10 from the first latching element 9 is also made possible when a sufficient force acts on the spreader element 4 against the locking direction 14.

The movement of the spreader element 4 in and against the locking direction 14 is carried out via a lever 6 as part of a movement mechanism of the spreader element 4. The lever 6 is rotatably supported relative to the male contact body 2 via a suspension 7, wherein a first leg of the lever 6 engages a recess 16 of the spreader element 4 formed in a portion of the spreader element 4 that protrudes from the male contact body 2 in the locking direction 14. The lever 6 is movable between an open position of a closed position, so that the spreader element 4 is moved between the loose position and the tightened position. In this regard, the lever has an opening through which a hook 8 attached to the male contact body 2 snaps into place when the lever 6 reaches the closed position. This locks the lever 6 in the closed position so that the spreader element 4 cannot leave the tightened position. This creates an additional securing of the spreader element 4 in the tightened position and thus an additional securing of the contact pressure between the male contact body 2 and the female contact 3. The hook 8 is thereby formed in such a way that the engagement with the lever 6 can be manually released when a transfer of the lever 6 from the closed position to the open position is to be carried out.

In the embodiment shown, a housing 5 surrounds the male contact body 2 in certain areas and forms an assembly with the latter as well as with the lever 6 and the spreader element 4. In this case, the housing 5 has a first housing part 11 and a second housing part 12.

The first housing part 11 forms the suspension 7 and the hook 8. In addition, the first housing part 11 forms a cap 17 in which the region of the spreader element 4 extending from the male contact body 2 in the locking direction 14 is enclosed. The cap 17 has an opening in the direction of the lever 6, so that the lever 6 can engage in the recess 16 of the spreader element. The cap 17 thus serves as dust protection and as protection against force influences on the spreader element 4 against the locking direction 14, which are not caused by a movement of the lever 6.

The second housing part 12 encloses the male contact body 2 with a certain distance in the area which is guided into the female contact 3, whereby the second housing part is primarily formed as a sleeve. This distance is chosen in such a way that the female contact body can be inserted between the second housing part 12 and the male contact body. This facilitates the placement of the male contact body 2 in the female contact 3 and an effective dust protection of the two contact elements occurs. The second housing part 12 is designed in such a way that the female contact 3 is stabilized from the outside during the spreading of the male contact body 2 by the movement of the spreader element 4 into the tightened position, so that deformations of the female contact 3 are counteracted.

The two-part design of the housing 5 simplifies the assembly of the housing 5 as well as the entire assembly of housing 5, lever 6 and spreader element. In addition, the two housing parts 11, 12 can also be made of different materials in order to further adapt the properties of the housing parts 11, 12 to the respective intended use.

FIGS. 5a, 5b and 5c show how the embodiment of the connecting device is assembled, wherein the female contact 3 is here attached to a step-shaped connecting element 20. The female contact 3 is thereby seated on a lower surface of the step-shaped connecting element 20 and may also be manufactured integrally therewith. The step-shaped connecting element 20 is surrounded by an insulating material 21 in the area of the lower surface and a section arranged thereon, wherein an additional housing 22 is formed around the female contact 3 from the insulating material.

Here, between the additional housing 22 and the female contact 3 is a space into which the housing 5 of the assembly of housing 5 and male contact body 2 can be inserted when the male contact body 2 is inserted into the female contact 3. Here, the additional housing 22, the housing 5, the female contact 3 and the spreader element 4 are all aligned coaxially with each other. In order to now expand the male contact body 2 within the female contact 3, the lever 6 is transferred from its open position, see FIG. 5b, to its closed position, see FIG. 5c. This moves the spreader element 4 in the locking direction 14 into the male contact body 2, thereby spreading it open. In FIG. 5b, it can be seen how the hook 8 snaps onto the lever 6 and fixes it in its closed position. The arrangement of the male contact body 2 to the female contact 3 as well as the closing of the contact by transferring the lever 6 into the closed position is very simple due to this design and requires only a few work steps, which can additionally be easily automated by a robot.

FIG. 6 shows a section through the connection device 1 according to the arrangement in FIG. 5c. Due to the arrangement of the male contact body 2 and the female contact 3 in the housing 5 and the additional housing 22, the electrical connection between the male contact body 2 and the female contact 3 can be very well insulated and there is also good protection against contamination.

### REFERENCE SIGN

Electrical connection device 1
Male contact body 2
Female contact 3
Spreader element 4
Housing 5
Lever 6
Suspension 7
Hook 8
First latching element/groove 9
Second latching element/bead 10
First housing part 11
Second housing part 12
Finger 13
Locking direction 14
Insertion direction 15
Recess 16
Cap 17
Slot 18
Bridges 19
Stepped connecting element 20
Insulating material 21
Additional housing 22

1. An electrical connection device comprising a female contact and a male contact body configured such that the male contact body is insertable into the female contact along an insertion direction and the male contact body has a cavity extending through the male contact body, the cavity being bounded by an inner surface of the male contact body, the device further comprising a spreader element inserted into the cavity, which has cross-sections tapering along its longitudinal axis in a locking direction, the spreader element being transferable along the locking direction from a released position to a tightened position in such a way that the male contact body is spread open and a contact pressure is thereby generated between the female contact and the male contact body, wherein device has a housing which surrounds the male contact body at least in regions, wherein the housing forms an assembly with the male contact body, and wherein an additional housing forms an assembly with the female contact and is configured such that the housing of the assembly with the male contact body is insertable between the additional housing and the female contact.

2. (canceled)

3. The electrical connection device according to claim 1, wherein the housing is configured such that the female contact is insertable between the male contact body and a housing part, the housing part preferably stabilising the female contact during spreading of the male contact body from the outside.

4. (canceled)

5. The electrical connection device according to claim 1, wherein the inner side of the male contact body has a first latching element and an outer side of the spreader element has a second latching element, the first latching element latching with the second latching element when the spreader element reaches the tightened position, so that a securing of the spreader element in the tightened position is produced.

6. The electrical connection device according to claim 5, wherein the cavity tapers in the locking direction such that the male contact body spreads out in such way that a planar contact between the inner side of the male contact body and an outer surface of the spreading spreader element is obtained when the spreader element is in the tightened position.

7. The electrical connection device according to claim 5, wherein the first latching element and/or the second latching element have a rounding so that non-destructive release of the latching between the first latching element and the second latching element is possible by applying force to the expanding element in the opposite direction to the locking direction.

8. The electrical connecting device according to claim 5, wherein the male contact body has slots at its axial end lying opposite the locking direction, so that the male contact body can be spread open in this region under the action of less force by the spreader element.

9. The electrical connection device according to claim 5, wherein the a cross-sectional area of the cavity and a cross-sectional area of the spreader element each have a circular shape, preferably a circular area.

10. The electrical connection device according to claim 5, wherein the spreader element has the second latching element as a circumferential projection on its outer side and the male contact body has the second latching element as a circumferential groove on its inner side, wherein the projection and the being formed in a form-fitting manner with respect to one another.

11. The electrical connection device according to claim 10, wherein the circumferential projection and the circumferential groove are configured such that the spreader element is non-destructively movable into and out of the tightened position by sliding a surface of the projection off a surface of the groove, under the action of a force acting in or against the locking direction on the spreader element.

12. The electrical connection device according to claim 5, wherein the device comprises a movement mechanism which causes the movement of the spreader element, the movement mechanism being lockable when the spreader element is in the tightened position.

13. The electrical connection device as claimed in claim 12, wherein the movement mechanism comprises a lever which is rotatably mounted about a pivot axis relative to the male contact body, wherein a first leg of the lever attaches to a region of the spreader element which extends out of the cavity of the male contact body in the locking direction such that movement of the lever between an open position and a closed position causes movement of the spreader element between the released position and the tightened position.

14. The electrical connection device according to claim 13, wherein the lever is mounted on the housing.

15. The electrical connection device according to claim 13, wherein a releasable securing of the lever locks the lever in the closed position as soon as the lever reaches the closed position.

16. The electrical connection device according to claim 15, wherein the securing of the lever is designed as a snap element in the form of a hook, whereby the hook hooks onto a second leg of the lever, which is opposite the first leg of the lever with respect to the pivot axis, when the lever is transferred from the open position to the closed position.
